(19) United States
(12) Patent Application Publication
(10) Pub. No.: US 2020/0156487 A1
(43) Pub. Date: May 21, 2020

(54) Steam Powered Green Energy Electric Vehicle Charging System

(71) Applicant: Rizgar Nader, Brooklyn, NY (US)

(72) Inventor: Rizgar Nader, Brooklyn, NY (US)

(21) Appl. No.: 16/198,375

(22) Filed: Nov. 21, 2018

(51) Int. Cl. B60L 53/10; F01K 7/16; B60L 53/66; B60L 55/00; G06Q 50/06; G06Q 30/04

(52) U.S. Cl. CPC B60L 53/11; F01K 7/165; G06Q 30/04; B60L 55/00; G06Q 50/06; B60L 53/665

(57) ABSTRACT

Systems and methods for utilizing steam powered “green energy” for an electric charging system for charging electric vehicles are disclosed. A control unit may manage the electricity generation and delivery to a high voltage charging station, e.g., 480+V. A steam source may provide pressurized steam to a turbine and generator to generate electricity, or store it for later in a storage unit, for delivery to the charging station. The control unit may assist in regulating the flow of the pressurized steam through one or more valves. The control unit may also be in communication with, at least, the generator and charging station to identify charging requirements, manage electricity distribution and consumption, deliver electricity to the charging station, and determine billing based on delivery. Generated electricity may be “stored” in the batteries of an electric vehicle when the batteries are charged, and then later, the vehicle's batteries may be utilized in a “vehicle-to-grid” system whereby the electrical power in the vehicle's batteries is supplied, e.g., through a home Level 2 charging station with vehicle-to-grid technology, to the electrical grid.

### BACKGROUND OF THE INVENTION

Recent years have seen a marked increase in the use of electric vehicles as personal automobiles. The adoption of such environmentally conscious transport has been aided by advances in technology (e.g., batteries for energy storage) allowing for a longer range of travel before the vehicle's batteries must be recharged. The batteries of an electric vehicle typically operate on DC (direct current), and therefore, need a DC power source to recharge. Most electricity, e.g., in homes and commercial settings, is in the form of AC (alternating current). Thus, in order to charge the electric vehicle batteries, there is typically some form of conversion of AC power into DC power, by way of a rectifier, for example. In some vehicles, the circuitry needed to convert AC power into DC power is built into the vehicle itself. For these types of vehicles, charging simply requires connection to an AC power source. In other vehicles which do not have such conversion capabilities, they must be connected to a DC source of power.

The charging systems for electric vehicles include Level 1 chargers which operate on standard 120V AC power. The maximum power which can be provided by a Level 1 charger is on the order of 2 kW when using a standard 20 amp, 120V wall outlet. At this 2 kW power level, to fully charge the batteries of an electric vehicle having a capacity of 100 kW would require a time on the order of 50 hours. Accordingly, since Level 1 chargers are less than ideal in terms of speed of charging, there has also been developed Level 2 chargers, which operate on 240V AC power, and can provide power at a rate of 19 kW (based on an 80 amp limited power source). At this higher power level, fully charging a 100 kW battery requires a time of approximately five hours. Level 1 and Level 2 chargers typically provide AC power to the vehicle, which in turn coverts to the necessary DC to charge the vehicle's batteries.

Beyond Level 2 chargers, there has also been developed Level 3 Charging. Level 3 chargers utilize high voltage AC, and in contrast to Level 1 and Level 2, deliver DC power directly to the electric vehicle battery. The DC power is typically provided at a voltage of 480V and higher current levels, which result in power delivery in the range of 60 kW to as much as 120 kW. At these higher power levels, much less time is needed to charge the vehicle's batteries. For example, Level 3 Charging systems may charge an electric vehicle's battery up to 80% of its full capacity in under one hour. Level 3 chargers are sometimes referred to as DC fast chargers. Advanced Level 3 Charging, also known as Ultra Fast charging can deliver 350 kW or more, and may fully charge an electric vehicle's battery in as little as 10-15 minutes.

Level 3 Charging and Advanced Level 3 Charging are not as prevalent as Level 2 Charging, often due to unit price and the costs related to installation and power consumption. For example, installation costs include, among other items, equipment such as transformers and switches, and installation of high voltage cable lines over substantial distances. Regulatory hurdles can also lengthen the installation process of Level 3 Charging and Advanced Level 3 Charging, and in some cases, may take years to obtain. The high rate of electrical power consumption for these types of chargers also results in higher maintenance costs, and in some areas, this level of electrical power consumption renders high voltage chargers unfeasible and/or unsustainable due to the strain placed on power grids that were neither engineered nor designed for an extremely high rate of consumption. At the same time, the use of slower, Level 2 Charging disincentivizes and impedes the conversion of the automotive vehicle industry from fossil fuel-based vehicles to electric vehicles. For example, to date Tesla has built only four Level 3 Charging stations in heavily urban Manhattan since the production of its first EV in 2008. It plans to build another four charging stations in Manhattan by 2019, bringing the total to only eight stations. However, it is estimated that there are approximately 1.7 million vehicles in Manhattan on any given work day, with an increasing percentage of these vehicles being electric vehicles. Thus, there is an inadequate amount of high power charging stations. Additionally, there are no Advanced Level 3 Charging stations in Manhattan.

Steam power is an example of a clean energy which has been utilized to generate electricity from the kinetic energy, specifically the high pressure of the gaseous steam. Steam power can be derived from multiple sources, including, but not limited to: 1) steam distribution networks that are utilized in many locations, especially urban locations such as the Con Ed steam distribution network in New York City, which provide a clean energy power source to businesses, including industrial plants and manufacturing facilities, as well as hospitals, schools and universities, residences and other venues; 2) steam generators that are located at large buildings or installations such as industrial plants, manufacturing facilities, hospitals, universities, and others that are not accessible to a steam distribution network; 3) municipal electric power plants which primarily produce electricity, but also produce steam as waste; and 4) municipal steam generating plants which produce steam only. Each of these different sources is referred to as a “Steam Source”. Steam may be utilized for applications such as air-conditioning, heating, cleaning, water distribution, humidification, as well as electric energy production.

Steam turbines, in particular, provide an efficient means for converting the steam's kinetic energy into mechanical energy, which may then be converted into electrical energy. A pressurized steam flow contacts a series of blades within a turbine, and provides power to efficiently rotate a number of blades connected to a rotatable shaft. The mechanical energy from the rotating shaft may then be converted to electrical energy. For example, one end of the turbine shaft may be situated within a generator. That end of the turbine shaft may be surrounded with a conductive material, e.g., a copper wire coil. The turbine shaft rotates within a magnetic field, and creates an electric current in the copper wire, which may be stored and/or utilized for electric applications.

### SUMMARY OF THE INVENTION

The present disclosure relates to systems and methods for utilizing steam power for charging electric vehicles. According to an aspect of the present invention, a system for charging electric vehicles includes pressurized steam received from a Steam Source, at least one valve regulating a flow of the pressurized steam, a steam turbine to receive the pressurized steam and a generator to generate electricity, a high voltage charging station configured to deliver the generated electricity to an electric vehicle, and a control unit in communication with the generator and the high voltage charging station, which is also configured to manage electricity generation and delivery to the high voltage charging station. Generated electricity may also be stored in one or more storage units until required later for distribution and delivery to an electric vehicle. Storage units may be utilized to help meet peak energy demands, e.g., when a rate of consumption exceeds the rate of electricity generation, and may be managed by the control unit. Similarly, generated electricity may be “stored” in the batteries of an electric vehicle when the batteries are charged, and then later, the vehicle's batteries may be utilized in a “vehicle-to-grid” system whereby the electrical power in the vehicle's batteries is supplied, e.g., through a home Level 2 charging station with vehicle-to-grid technology, to the electrical grid. In this way, steam generated electrical power is injected into the electrical grid, thereby reducing reliance on fossil fuels.

The Con Edison steam distribution system delivers steam at high pressure, from 100-250 psig (psi gauge, or psi relative to atmospheric pressure), to venues which then reduce it to 5-30 psig for consumption using a pressure reduction valve(s) (“PRV”). The same pressure reduction achieved by the PRV can be obtained instead with, e.g., a valve that diverts all of, or a portion of the steam pressure to a steam turbine and generator system. This way, the same excess pressure that is released by the steam during the process through which the steam passes through the PRV is utilized by the steam turbine and generator system at no additional cost. The steam utilized from the Steam Source is “green energy” because it is excess, waste steam pressure that would otherwise have been wasted, but is instead utilized to generate electricity to charge electric vehicles. In embodiments, the Steam Source may include recycled steam, such as steam that has already passed through the steam turbine. Excess steam from the turbine may be used in one or more subsequent applications, such as heating, air conditioning, humidification, and water systems. For example, in the case of electrical power generation, each 4 lb/hr of steam is capable of generating 1 kWe of electricity that can be used to charge electric vehicles. If a typical venue uses 10,000 lb/hr of steam, a steam turbine and generator system could generate up to 270 kWe of electricity without really affecting the delivery of the needed steam to the venue.

In embodiments, the control unit may be in network communication, e.g., wired or wireless, with the generator and high voltage charging station. The control unit may also be in communication with at least one of the steam turbine(s) and at least one valve, wherein the control unit further manages electricity generation by adjusting at least one valve to adjust a flow of the pressurized steam. The control unit may also receive feedback to adjust electricity generation, storage and delivery. The high voltage charging station may supply at least 480V, and utilize AC and/or DC power.

In embodiments, systems and methods may further include one or more storage units, in communication with the control unit, for storing generated electricity and delivering electricity to the high voltage charging station at a different time. The storage units may be located either in the vicinity of the control unit, and/or in the vicinity of the generator.

Various embodiments may utilize one or more charging requirements particular to the high voltage charging station, e.g., vehicle battery capacity, current vehicle battery charge level, and power delivery capability of the charging station, to manage the electricity generation and delivery. One or more billing methods may be implemented with disclosed systems and methods, to enable widespread use and consumption of electric charging stations for all different types of electric vehicles. Billing may be based on one or more of a time of charging, e.g., during peak or off-peak hours, a length of charging, and the type of charging station used.

### BRIEF DESCRIPTION OF THE DRAWINGS

The foregoing and other features of the present disclosure will become more fully apparent from the following description, taken in conjunction with the accompanying drawings. These drawings depict only several embodiments in accordance with the disclosure and are therefore, not to be considered limiting of its scope. The disclosure will be described with additional specificity and detail through use of the accompanying drawings.

In the drawings:

FIG. 1 is a diagram of an exemplary steam powered electrical charging system in accordance with an embodiment of the present invention;

FIG. 2 is a flowchart illustrating an electrical vehicle charging process in accordance with an embodiment of the present invention;

FIG. 3 is a flowchart illustrating additional aspects of electrical vehicle charging in accordance with an embodiment of the present invention; and

FIG. 4 is a diagram of an embodiment of the present invention including vehicle-to-grid technology.

### DETAILED DESCRIPTION OF ILLUSTRATIVE EMBODIMENTS

Various examples of the present invention described herein are generally directed to systems and methods for, among other things, utilizing steam power to charge electric vehicles. It will be understood that the provided examples are for purposes of clarity and understanding, and are not meant to limit or restrict the claimed subject matter or relevant portions of this invention in any manner.

According to an aspect of the present invention, Steam Sources may be utilized to produce electrical power for charging electric vehicles. Steam Sources, include, but are not limited to: 1) steam distribution networks that are utilized in many locations, especially urban locations such as the Con Ed steam distribution network in New York City, which provide a clean energy power source to businesses, including industrial plants and manufacturing facilities, as well as hospitals, schools and universities, residences and other venues; 2) steam generators that are located at large venues such as industrial plants, manufacturing facilities, hospitals, universities, and others that are not accessible to a steam distribution network; 3) municipal electric power plants which primarily produce electricity, but also produce steam as waste; and 4) municipal steam generating plants which produce steam only. The Steam Source may also be subsequently utilized for a variety of applications. Such applications include heating, air conditioning, and generating electrical power.

A variety of methods may be implemented to utilize the energy associated with the steam. For example, steam turbines at the one or more locations may receive the pressurized steam from the Steam Source, and convert the steam energy to electrical energy. In embodiments, steam turbines may be specifically designed to receive the pressurized steam and directly generate power for electric car charging stations. Integrating steam power with electrical applications may help reduce the need for non-renewable energy sources, devices, and systems that require electrical power, as well as provide a cost-efficient and effective alternative to traditional methods.

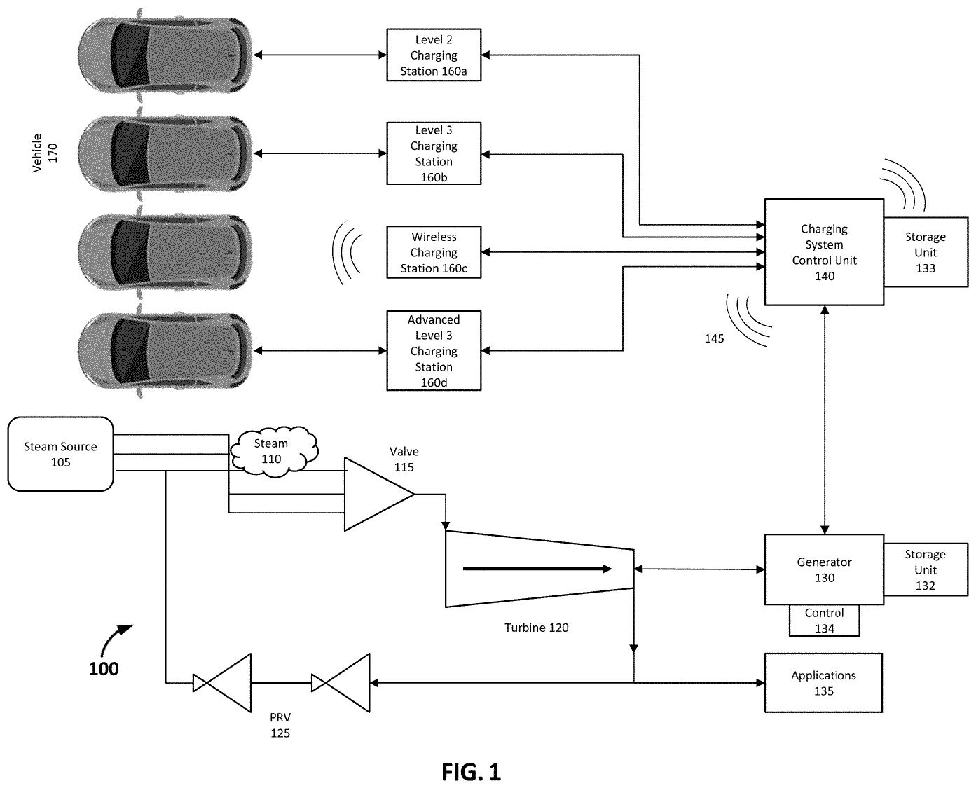

FIG. 1 illustrates an example of a steam powered system 100 for charging electric vehicles, according to embodiments of the present invention. Steam 110 may be received from one or more steam-generating plants or steam sources 105, which may be at a same or different location as the steam-powered charging system, and part of a steam power network. One such example of a steam power network is New York City's Con Edison steam distribution system, which delivers pressurized steam through an underground pipeline system to businesses, residences, and locations throughout the city. In an aspect of the invention, pressurized steam 110 from the steam networks may be directed through one or more valves 115 to a steam turbine 120, which may be present or installed in or near a building, residence, outdoor location, or other location connected to the steam network. The valves 115 may be pressure regulating valves, and/or may also be pressure reduction or regulating stations, for example, and may control the flow of the steam 110. The valves may be managed by a control unit 134 associated with the generator 130 and turbine 120, e.g., a power management unit, as described herein, and may be controlled by physical means, e.g., manually opening or closing the valves. The valves may be present within a building's internal steam system network, and may assist in regulating the amount and direction of the steam 110 throughout the network and to the various delivery locations. For example, one or more volumetric flow meters may communicate a current velocity, pressure, and/or temperature of the steam flow to a computer, e.g., control unit 134, which may, in turn, regulate one or more physical aspects of the steam network to produce a steam flow with the ideal pressure and other properties prior to delivery to the turbine.

The steam turbine 120 may receive the pressurized steam 110 and utilize the flow to generate electrical energy at a generator 130. The operation and control (e.g., user interface) of the generator 130 and turbine 120 may be directed by a control unit 134 associated with the generator 130. In embodiments, the steam turbine 120 may be an extraction turbine or non-condensing steam turbine. In other embodiments, the turbine includes a number of rotors and stators to efficiently rotate a shaft connected to a generator 130. The generator 130 utilizes the turbine shaft's rotation within a magnetic field to generate an electrical current directly proportional to its rotation. In embodiments, the steam turbine 120 may be directly connected to the source of the pressurized steam 105, for example through pipelines and valves connected from the external and/or internal steam network to the turbine. The control unit 134 associated with the generator 130 may, for example, provide a control system screen which provides information regarding the input steam. This information may include steam inlet pressure, steam outlet pressure, steam inlet temperature, steam outlet temperature, steam valve position, and steam flow. The control unit 134 may also provide information on the electricity output, such as kilowatts generated (kWe), generator voltage, and generator current.

In other embodiments, the steam turbine 120 may utilize excess steam after the pressurized steam has passed through one or more turbines and/or electricity extraction methods. The steam turbine 120 may also use pressurized steam directly from the steam network and/or waste/excess steam. For example, as illustrated in FIG. 1, excess steam from the turbine may be redirected through one or more pressure regulating valves (PRV) 125 and recycled back through the valve 115 and the turbine 120 to generate electricity from the steam power.

After interaction with the steam turbine 120, the steam may be condensed into water, and/or subsequently utilized in one or more additional applications 135, including heating, humidification, and additional energy extraction techniques.

It will be appreciated that any of a plurality of steam turbine designs known in the art may be utilized in accordance with embodiments of the present invention. The functionality of steam turbine 120, generator 130, and control unit 134, as well as some of the related valve components, may be implemented by way of a Microsteam Power System provided by Carrier Corporation. It will also be understood that while embodiments are described as utilizing steam turbines to extract electrical energy, the present invention is not limited only to those technologies. Any of a plurality of systems and methods, which may include and/or utilize gas, oil, coal, water, electricity, combustion methods, etc., to produce electrical energy from steam, may also be used in accordance with one or more embodiments.

As discussed above, the generator 130 produces electricity from pressurized steam energy transferred to a rotating shaft within the turbine 120. In various embodiments, the generator 130 generates alternating current (AC), which may be subsequently converted to direct current (DC). In embodiments, either type of current may be utilized to charge a battery, fuel cell, capacitor, or other electrochemical cell storing electrical energy for subsequent consumption.

In one example, the generated electrical energy may be delivered directly to a battery for an electric vehicle. In other embodiments, the electrical energy may be utilized with high voltage chargers, such as Level 2 Charging Station 160a, Level 3 Charging Station 160b, Wireless Charging Station 160c, or Advanced Level 3 Charging Station 160d, to quickly and efficiently charge an electric vehicle. Level 2 chargers (160a), which operate on 240V AC power, can provide power at a rate of 19 kW (based on an 80 amp limited power source), fully charging a 100 kW battery in approximately five hours. Level 3 chargers (160b) deliver DC power directly to the electric vehicle at a voltage of 480V and higher current levels, which may charge an electric vehicle's battery up to 80% of its full capacity in under one hour. Wireless charging station 160c uses high power electromagnetic waves to deliver energy to an electric vehicle without requiring a direct connection between the electric vehicle and the charging station 160c. Advanced Level 3 Charging, also known as Ultra Fast charging can deliver 350 kW or more, and may fully charge an electric vehicle's battery in as little as 10-15 minutes. In all of these embodiments, one or more power managers, such as a control unit 140 may be present to manage the power flow from the generator prior to delivery to the electric vehicle.

In other examples, one or more storage units 132 may be in electrical connectivity with the generator 130 in order to store generated electricity until such energy is requested from the charging stations 160a, 160b, 160c or 160d to charge an electric vehicle 170 or other application. The storage units may continuously store generated energy until such energy is requested by one or more applications. During periods of low demand, the generated electricity would be stored in the storage units 132 and/or 133. In this manner, it may be ensured that energy is available for consumption, especially during peak delivery times, when high volumes of energy are requested or when the energy demand exceeds the rate at which electricity may be generated.

As discussed above, the charging system control unit 140 may manage and regulate the operation of the generator 130 to thereby control the flow of energy to the charging stations 160a, 160b, 160c or 160d, as well as to one or more storage units 132 and applications. The charging system control unit 140 may also have one or more associated storage units 133 in order to store generated electricity until such energy is requested from the charging stations 160a, 160b or 160c to charge an electric vehicle 170 or other application.

In various embodiments, the steam-generated electrical energy may be used in conjunction with various existing electric vehicle charging stations, providing an additional or exclusive source of energy for charging stations. In exemplary embodiments, the generated electricity will enable high voltage charging stations to efficiently receive green energy for high-speed charging. For example, the disclosed systems and methods may provide power to Tesla Supercharger™ stations, which are capable of supplying at least 480 V and electrical power up to approximately 90-135 kW. Embodiments may be modified, as necessary, to charge various types and sizes of batteries and storage units. For example, charging stations may be configured to receive electricity for charging a 480 V electrical vehicle battery pack, as well as electric vehicles with 40-100 kWh capacities.

It will also be appreciated that the electric vehicle charging stations are not limited to automobiles. In embodiments, the present invention may be utilized to charge electric bicycles, motorcycles, and/or any of a plurality of electric vehicles. The charging stations 160a, 160b or 160c and their respective power levels and delivery methods may be varied, for example, depending on the type of battery, battery capacity, and/or type of electric vehicle.

Embodiments may also include one or more charging system control units 140 to regulate various aspects of the electrical energy storage and delivery. The charging system control unit(s) 140 may utilize wired or wireless communication 145 to provide remote monitoring for one or more aspects of the system as described herein. For example, the charging system control unit 140 in conjunction with control unit 134 of the generator 130 may receive and transmit information to one or more of the valves 115, 125, turbine 120, generator 130, storage unit 132, storage unit 133, and any of the charging stations 160a, 160b, 160c to analyze aspects of the system, and manage power consumption and distribution. In this way, charging system control unit 140 may receive information regarding the status of turbine 120, generator 130, storage units 132, 133, and charging stations 160a, 160b, 160c, 160d, and similarly provide control signals to control the operation of each of these system components. Such monitoring and control of system components enable remote adjustments to each part of the system, which enables adaptations to varying power demands and unanticipated issues, such as failure of one or more components or other maintenance issues. Remote monitoring allows scheduling of one or more system aspects, such as steam delivery or electricity generation, for example, in anticipation of power demands. The efficient remote control and management of the system may thereby translate to economic savings and time efficiencies regarding management, maintenance, and general operation. The charging system control unit 140 may be co-located at the location where the other system components (e.g., turbine 120, generator 130, charging stations 160a, 160b, 160c) are located, or it may be located remotely from such location.

Utilizing steam power for electric vehicle charging can significantly reduce costs currently required for installing and using supercharging stations, as well as traditional electric vehicle charging stations. The systems and methods disclosed herein substantially ease the electrical strains that superchargers place on electrical grids, since electric power is no longer required or supplied from electrical grids. In addition, the present invention can significantly reduce and/or eliminate many electricity costs associated with high voltage charging stations. For example, many components traditionally associated with installing and utilizing high voltage charging stations are no longer necessary. Such components include transformers, and high voltage cable lines, which are often installed over substantial—and costly—distances.

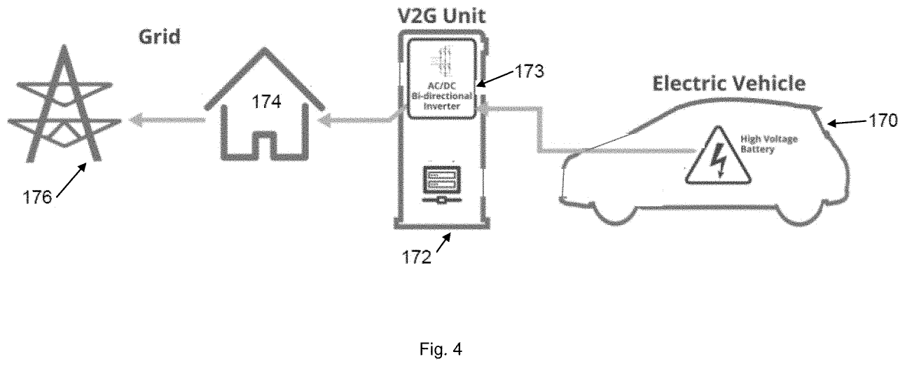

In an embodiment, steam generated electricity may be “stored” in the batteries of an electric vehicle when the batteries are charged, and then later, the vehicle's batteries may be utilized in a “vehicle-to-grid” system whereby the electrical power in the vehicle's batteries is supplied, e.g., through a home Level 2 charging station with vehicle-to-grid technology, to the electrical grid. In this way, steam generated electrical power is injected into the electrical grid, thereby reducing reliance on fossil fuels. Such an embodiment may also generate a financial profit when the cost of obtaining the steam generated electricity is less than the price which may be obtained for providing electricity to the electrical grid. Referring now to FIG. 4, therein is illustrated an embodiment of a system utilizing the vehicle-to-grid concept. In such a system, vehicle 170 may be interfaced to a vehicle-to-grid (V2G) unit 172 which may be provided as part of the home Level 2 charging system which may be located within or in the vicinity of a home 174. A function of the V2G unit 172 is to convert the electric power stored within the batteries of vehicle 170 into a form of electrical power suitable to be transmitted to the electrical grid 176. This conversion may involve converting DC power into AC power, as well as converting the voltage of the vehicle's stored electric power into a voltage suitable for the electrical grid 176. Some or all of this conversion may be accomplished by way of an AC/DC bidirectional inverter 173.

Moreover, given the substantial regulatory hurdles often present with installing electric cables and connecting high voltage charging stations to electrical grids, the present invention provides a distinct advantage with respect to installation time and cost, since there exists significantly less regulatory hurdles with respect to components of the disclosed systems. In addition, the present invention may provide substantial economic benefits. High voltage chargers provide a faster, more time-efficient charging capability for electric vehicles compared to traditional or conventional low voltage vehicle chargers. Faster charge times are more attractive to consumers and may help promote and incentivize additional manufacturing and adoption of electric vehicles in the auto industry. Likewise, the green, environmentally-friendly energy source may be even more attractive to consumers and/or manufacturers, given that such technologies will reduce the use of fossil fuels compared to traditional charging methods.

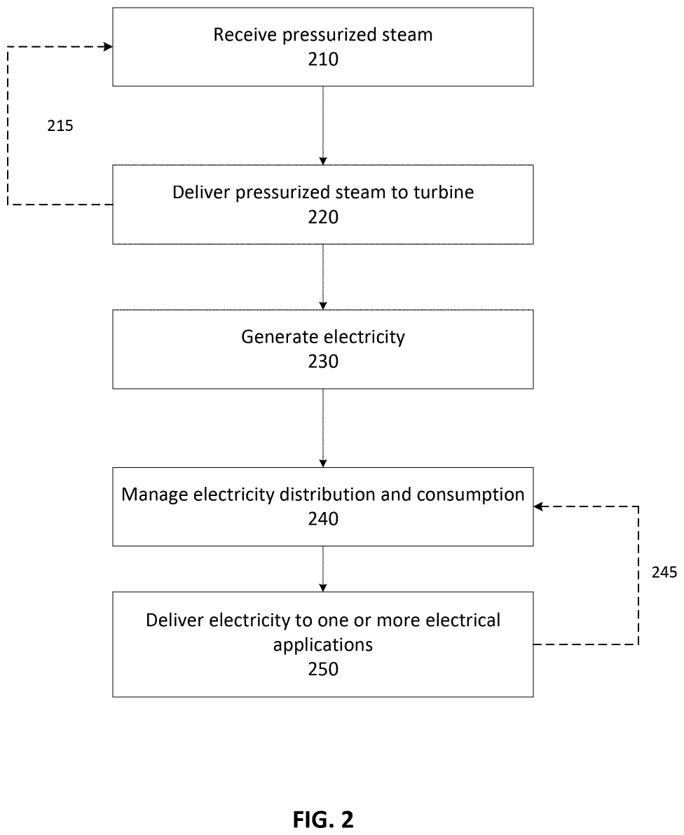

FIG. 2 is a flowchart depicting aspects of the operation of a steam powered electric charging system in accordance with one or more embodiments. At step 210, the system receives pressurized steam from a steam source. The steam may be delivered from a steam network including at least one steam-generating station or unit, e.g., a boiler, which may be at a same or different location as the turbine/generator complex, and the generating steam for consumption in one or more applications, including the electric charging system as described herein. In other embodiments, pressurized steam may be steam produced from one or more applications generating heat and water vapor. In yet another embodiment, steam may be excess or waste steam after use in one or more steam-consuming applications, such as the present turbine system.

At step 220, the pressurized steam is delivered to a steam turbine connected to a generator and configured to generate electricity, at step 230, from the energy associated with the pressurized steam. For example, the pressurized steam may flow into the turbine, past a plurality of rotors and stators, to rotate a turbine shaft connected to a generator. The generator utilizes the turbine shaft's rotation within a magnetic field to generate an electrical current directly proportional to the shaft's rotation. In embodiments, after the steam passes through the turbine, it may be recycled back through the system to the steam source and/or steam network, step 215, and again through the turbine to generate more electricity. It will be appreciated that the amount and pressure of the delivered steam may vary according to the type of turbine and/or generator used, the steam network, steam generator, and/or a desired electricity and power output from the system.

In embodiments, a control unit 134 associated with the generator 130, as discussed herein, may regulate the delivery of the pressurized steam to the turbine. The control unit 134 may, for example, control one or more valves to adjust an amount and/or pressure of the steam to the turbine. In various embodiments, the control unit 134 adjusts the steam based on a determined amount of steam necessary to generate an amount of electrical energy, feedback from one or more components of the system, and/or based on manual input from a user, supervisor, remote control program, etc.

In step 240, the distribution and/or consumption of generated electricity may be managed for delivery to one or more applications using one or more control units, e.g., charging system control unit 140. The charging system control unit 140 may regulate one or more aspects of the generated electricity, such as identifying one or more applications to receive the electricity, and managing the timing and delivery of electricity to charging stations 160a, 160b, 160c. In various embodiments, the flow of the pressurized steam, for example, through the control of one or more valves, and can be utilized in step 215 to recycle pressurized steam through the turbine system to generate additional power.

At step 250, one or more electrical applications receive the generated electricity. In various embodiments, generated electricity may be stored in one or more storage units 132, 133, such as electrochemical cells as described herein, for either direct use or energy storage for future consumption. The amount of power and location for delivery may be managed, for example, to prevent damage to the one or more applications using the electric power, ensure that the applications receive appropriate power levels, and ensure that electricity is available for use when needed by the one or more applications. As such, one or more quantifiable measurements related to the energy delivery to the application, e.g., battery capacity (kWh), current battery level, energy delivery rate (kWh), type of charger, etc., may be utilized as feedback, step 245, for subsequent adjustments to electricity distribution and consumption.

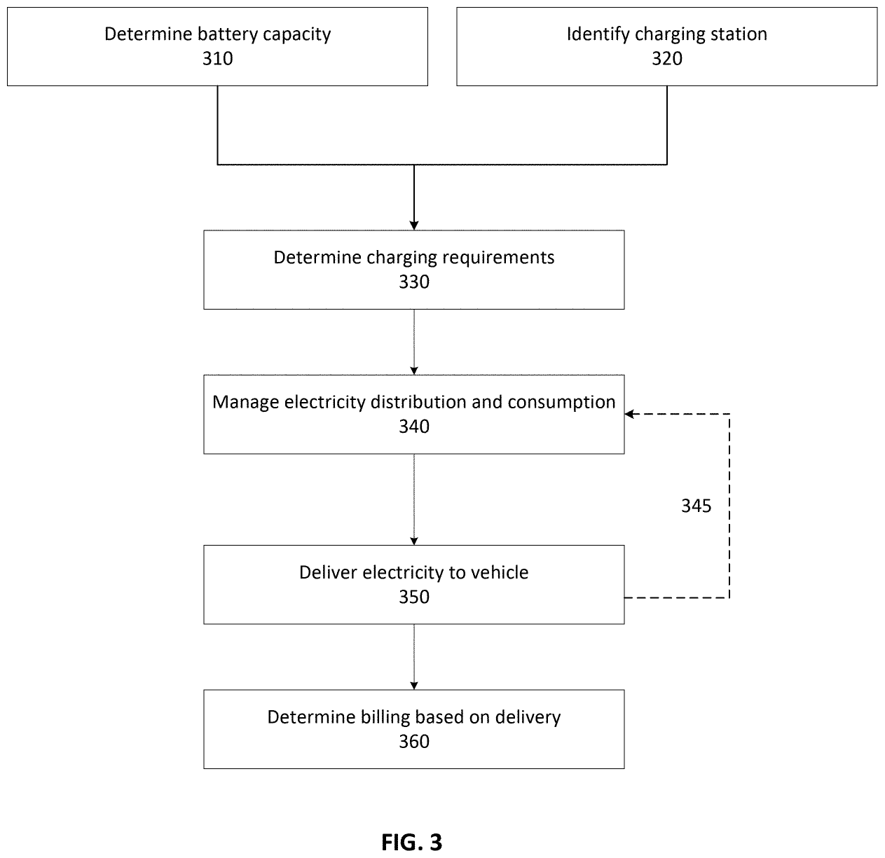

FIG. 3 illustrates an example method for electric vehicle charging, which may be utilized with one or more embodiments of the present invention. The charging system control unit 140 may manage one or more aspects of such methods, in order to determine an amount of electricity to be generated, delivered, and billed. Such methods may be utilized in connection with billing methods, to enable widespread use and consumption of such steam powered charging systems. In an embodiment, a request may be initiated at a charging station, to retrieve energy to charge an electric vehicle. Users may indicate a charging request through one or more input controls, through a remote request, or by physically connecting the electric vehicle to the charging station. In other embodiments, the request may be implemented similar to traditional electrical vehicle station charging methods.

In embodiments, users may be charged based on an amount of energy, kWh, consumed during the charging process. In other examples, users may be charged based on a time of charging, e.g., during peak or off-peak hours, a length of charging, and the type of charging station (standard vs. supercharger) or time spent at the charging station.

In the charging method, step 310 determines a capacity of the battery to be charged. This may include calculating a state of charge, which identifies the current battery capacity relative to the maximum capacity. Step 320 identifies information related to the charging station to which the electric vehicle battery is connected, such as a type of charging station, and power delivery capabilities, such as voltage and current.

Step 330 utilizes the battery capacity and charging station information to determine charging requirements. This may occur, for example, at charging system control unit 140 or a remote computing device, to determine one or more aspects related to charging the electric vehicle battery. Aspects may include an amount of power to be delivered, an optimum current level, and a timing for delivery. Accordingly, based on the determined amount of power required to charge the electric vehicle, one or more of these charging aspects may be managed and adjusted at step 340 to efficiently deliver electricity to the electric vehicle battery. For example, energy delivery may be regulated based on one or more of the type of charging station, a type of battery, the electric vehicle's battery capacity, a current state of charge, and an amount of generated electricity available for consumption. In embodiments, the electricity distribution and consumption management may be managed throughout the process of delivering energy to the electric vehicles/applications, step 345. For example, control of a charging station 160a, 160b, 160c, 160d may be managed to regulate the power flow to the charging station. Similarly, the charging station itself may be regulated to alter one or more aspects of power delivery throughout the charging process. In addition, the charging system control unit 140 in conjunction with control unit 134 of the generator, as disclosed herein, may adjust the operation of a turbine/generator complex to generate a desired or required amount of electricity for the requesting application. In other examples, the electricity management may be based on whether a credit, i.e., payment, has been provided to a charging station 160a, 160b, 160c, 160d to enable delivery to the electric vehicle.

Subsequently, one or more billing methods may be implemented in response to the energy delivery 360. For example, the charging station 160a, 160b, 160c, 160d may require a user to submit a payment based on the amount of energy delivered to the application, or based on an amount of time required for charging. The billing need not be limited to an amount of energy delivered, and may be based on a plurality of factors related to the system, e.g., steam consumption, etc., or other business and economic factors, such as billing based on the time the vehicle remains at the charging station, or remains at the charging station after the charging process has been completed.

It will be appreciated that while certain example embodiments have been described, these embodiments have been presented by way of example, for purposes of illustration, and are not intended to limit the scope of the inventions disclosed herein. Other aspects and embodiments will be apparent to those skilled in the art. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

What is claimed:

1. A system for charging an electric vehicle, comprising:
at least one valve regulating a flow of pressurized steam received from a steam source;
a steam turbine to receive the pressurized steam and generate electric power by way of a generator;
a charging station configured to deliver the generated electric power to an electric vehicle; and
a control unit in communication with the generator and the charging station, and configured to manage electric power generation and delivery to the charging station.

2. The system of claim 1, wherein the steam source is provided by way of a steam distribution network supplying steam to buildings.

3. The system of claim 1, wherein the charging station includes a Level 2 charging station.

4. The system of claim 1, wherein the charging station includes a high voltage charging station which supplies at least 480 V.

5. The system of claim 1, wherein the charging station includes a wireless charging station.

6. The system of claim 1, wherein the control unit communicates with the generator and the charging station via network communication.

7. The system of claim 1, wherein the control unit is remotely located with respect to the charging station or the generator.

8. The system of claim 1, wherein the control unit is in communication with one or more of the steam turbine and the at least one valve.

9. The system of claim 6, wherein the control unit manages electric power generation by regulating the at least one valve to adjust a flow of the pressurized steam.

10. The system of claim 1, wherein the control unit receives feedback from at least one of the generator and the charging station to adjust electric power generation.

11. The system of claim 1, wherein the control unit receives feedback from at least one of the generator and the charging station to adjust electric power generation by the generator or delivery of electric power to the vehicle by the charging station.

12. The system of claim 1, further comprising a storage unit for storing generated electric power, and delivering electric power to the charging station at a time subsequent to the generation of the stored electric power.

13. The system of claim 12, wherein the storage unit is in communication with and associated with the control unit.

14. The system of claim 12, wherein the storage unit is in communication with and associated with the generator.

15. The system of claim 1, wherein excess steam from the steam turbine is used in one or more subsequent applications.

16. The system of claim 15, wherein the subsequent applications include heating, air conditioning, humidification, and water systems.

17. A method for charging an electric vehicle, comprising:
receiving, at a control unit, a request for electric power from a charging station;
identifying one or more charging requirements based on the request;
delivering to the charging station, electric power based on the one or more charging requirements,
wherein the electric power is generated from a flow of pressurized steam to a steam turbine and generator, wherein the control unit regulates one or more of the flow of the pressurized steam, and an amount of electric power generated from the steam turbine and generator; and
managing, at the control unit, delivery of the generated electric power to the charging station, based on the one or more charging requirements.

18. The method of claim 17, wherein the one or more charging requirements include the battery capacity of the electric vehicle, a current vehicle battery charge level, and the charge capacity of the charging station.

19. The method of claim 17, wherein the control unit controls one or more valves to regulate the flow of the pressurized steam.

20. The method of claim 17, wherein the control unit regulates the flow of pressurized steam in response to at least one of an amount of generated electric power delivered to the charging station, and feedback information received from the charging station.

21. The method of claim 17, wherein the pressurized steam comprises recycled steam from the steam turbine.

22. The method of claim 17, wherein the charging station includes a Level 2 charging station.

23. The method of claim 17, wherein the charging station includes a high voltage charging station which supplies 480 Volts.

24. The method of claim 17, wherein the charging station includes a wireless charging station.

25. The method of claim 17, further comprising, determining a billing amount based on an amount of electric power delivered to the charging station.

26. The method of claim 17, wherein the control unit is remotely located with respect to the charging station or the generator.

27. The method of claim 17, further comprising, determining a billing amount based on an amount of time for charging the electric vehicle.

28. The method of claim 17, further comprising, determining a billing amount based on the amount of time that the vehicle remains at the charging station.

29. The method of claim 17, further comprising, determining a billing amount based on the amount of time that the vehicle remains at the charging station after the charging is completed.

30. The method of claim 17, further comprising storing generated electric power at a storage unit connected to the control unit.

31. The method of claim 17, further comprising storing generated electric power at a storage unit connected to the generator.

32. A system for charging an electric vehicle, comprising:
at least one valve regulating a flow of pressurized steam received from a steam distribution network supplying steam to a building;
a steam turbine to receive the pressurized steam and generate electric power by way of a generator;
a high voltage charging station configured to deliver the generated electric power at a voltage of at least 480 volts to an electric vehicle; and
a control unit in communication with the generator and the charging station, and configured to manage electric power generation and delivery of the electric power by the charging station to the electric vehicle.

33. The system of claim 32, further comprising a storage unit for storing generated electric power for subsequent delivery to the charging station at a later time.

34. The system of claim 32, wherein the control unit is located remotely with respect to the charging station or the generator.

35. The system of claim 32, wherein the control unit receives feedback from at least one of the generator and the charging station to adjust electric power generation by the generator or delivery of electric power to the vehicle by the charging station.

36. A method for generating electric power for injection into an electrical grid by way of an electric vehicle battery, comprising:
receiving, at a control unit, a request for electric power from a charging station;
identifying one or more charging requirements of the electric vehicle battery based on the request;
delivering to the charging station, electric power based on the one or more charging requirements,
wherein the electric power is generated from a flow of pressurized steam to a steam turbine and generator, wherein the control unit regulates one or more of the flow of the pressurized steam, and an amount of electric power generated from the steam turbine and generator;
managing, at the control unit, delivery of the generated electric power to the charging station, based on the one or more charging requirements;
delivering electric power to the vehicle battery by way of the charging station; and
at a subsequent time, providing a portion of the electric power from the vehicle battery to the electrical grid.

37. The method of claim 36, wherein the one or more charging requirements include the battery capacity of the electric vehicle, a current vehicle battery charge level, and the charge capacity of the charging station.

38. The method of claim 36, wherein the control unit controls one or more valves to regulate the flow of the pressurized steam.

39. The method of claim 36, wherein the control unit regulates the flow of pressurized steam in response to at least one of an amount of generated electric power delivered to the charging station, and feedback information received from the charging station.

40. The method of claim 36, wherein the pressurized steam comprises recycled steam from the steam turbine.

41. The method of claim 36, wherein the charging station includes a Level 2 charging station.

42. The method of claim 36, wherein the charging station includes a high voltage charging station which supplies 480 Volts.

43. The method of claim 36, wherein the charging station includes a wireless charging station.

44. The method of claim 36, further comprising, determining a first billing amount based on a first amount of electric power delivered to the charging station and a second billing amount based on a second amount of electric power delivered from the vehicle to the electrical grid.

45. The method of claim 36, wherein the control unit is remotely located with respect to the charging station or the generator.
